(19) United States
(12) Patent Application Publication
(10) Pub. No.: US 2002/0139225 A1
(43) Pub. Date: Oct. 3, 2002

(54) Adjustable spanner wrench

(76) Inventor: Brock T. Carter, Strongsville, OH (US)

Correspondence Address: TROLLI, SUNDHEIM, COVELL,, TUMMINO & SZABO L.L.P., 1111 LEADER BLDG., 526 SUPERIOR AVENUE, CLEVELAND, OH, 44114-1400, US

(21) Appl. No.: 09/817,991

(22) Filed: Mar. 27, 2001

(51) Int. Cl. B25B 13/10; B25B 13/56

(52) U.S. Cl. 81/176.3

(57) ABSTRACT

An adjustable spanner wrench (10) includes a body portion (12) and a handle (14) connected to the body portion. The spanner wrench (10) also includes a fixed drive pin (40) fixedly connected to the body portion (12) and a movable drive pin (42) connected to the body portion. The movable drive pin (42) is slidable relative to the body portion (12) in a first linear direction (80) away from the fixed drive (40) pin and in an opposite second linear direction (82) towards the fixed drive pin. The spanner wrench (10) also includes a biasing member (54) that biases the movable drive pin (42) in the first linear direction (80) away from the fixed drive pin (40).

### FIELD OF THE INVENTION

The present invention relates to an adjustable spanner wrench.

### BACKGROUND OF THE INVENTION

Known spanner wrenches include drive pins for engaging spaced sockets in a rotatable article, such as a cap, lid or cover. The known spanner wrenches also include a handle for rotating the drive pins in order to impart rotation of the rotatable article. Adjustable spanner wrenches are also known. The known adjustable spanner wrenches require that the position of the drive pins be manually adjusted prior to engaging the drive pins with the sockets.

One common instance for which the use of the spanner wrench may be required to rotate a rotatable article relates to applications upon a boat, yacht, or other similar watercraft. In such instances, removable covers used to access fuel and water containers are typically fit with spaced apart sockets and require the use of a spanner wrench to remove and/or fasten the covers. Such covers may be located in a housing that is recessed from a surface of the watercraft, which may make it difficult to adjust the spanner wrench because of the confined space in the housing.

### SUMMARY OF THE INVENTION

The present invention relates to an adjustable spanner wrench. The spanner wrench includes a body portion and a handle connected to the body portion. The spanner wrench also includes a fixed drive pin fixedly connected to the body portion and a movable drive pin connected to the body portion. The movable drive pin is slidable relative to the body portion in a first linear direction away from the fixed drive pin and in an opposite second linear direction towards the fixed drive pin. The spanner wrench also includes a biasing member that biases the movable drive pin in the first linear direction away from the fixed drive pin.

### BRIEF DESCRIPTION OF THE DRAWINGS

The foregoing and other features of the present invention will become apparent to one skilled in the art to which the present invention relates upon consideration of the following description of the invention with reference to the accompanying drawings, in which:

FIG. 1 is a perspective view of an adjustable spanner wrench, according to a first embodiment of the present invention;

FIG. 2 is an exploded view of the apparatus of FIG. 1;

FIG. 3 is a top view of a cap housing in which the apparatus of FIG. 1 may be used;

FIGS. 4 and 5 are sectional schematic views illustrating the use of the apparatus of FIG. 1 in the cap housing of FIG. 3; and

FIG. 6 is a perspective view of an adjustable spanner wrench, according to a second embodiment of the present invention.

### DESCRIPTION OF PREFERRED EMBODIMENTS

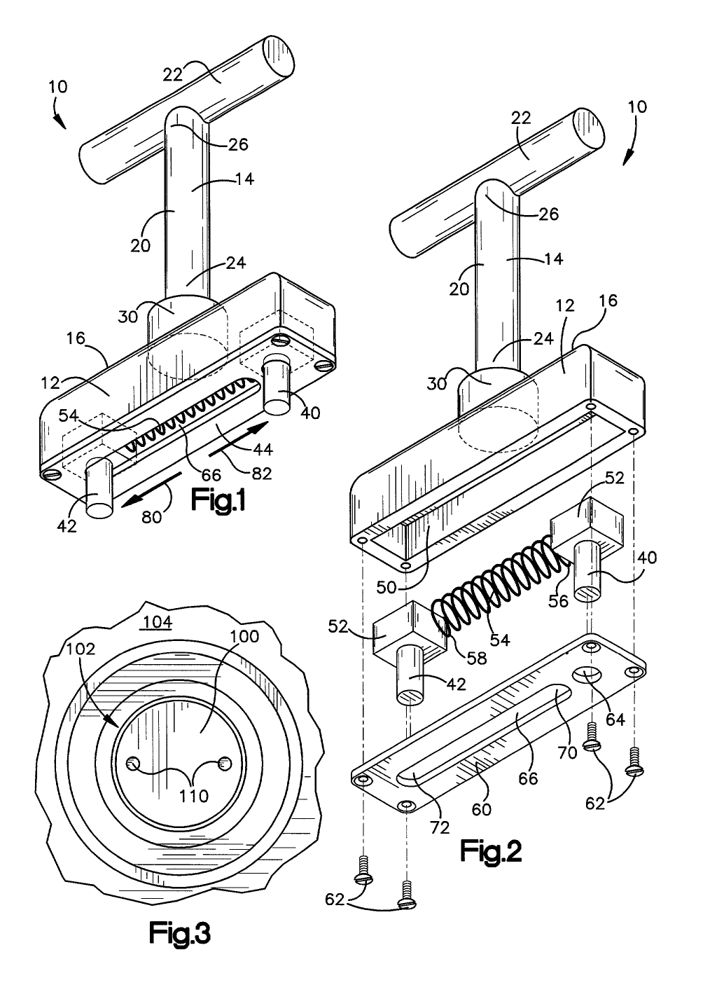

As representative of the present invention, an adjustable spanner wrench 10 is illustrated in FIGS. 1 and 2. The spanner wrench 10 includes a body portion 12 and a handle 14 connected to the body portion. The handle 14 extends generally perpendicularly from an upper surface 16 of the body portion 12. As illustrated in the figures, the body portion 12 has a generally elongated rectangular configuration. Those skilled in the art, however, will recognize that the body portion 12 may have an alternative configuration without affecting the operability of the spanner wrench 10.

The handle 14 includes a vertical member in the form of a shaft 20 and a cross-member in the form of a gripping portion 22. A first end 24 of the shaft 20 is connected to the upper surface 16 of the body portion 12. The first end 24 of the shaft 20 is inserted into a cylindrical sleeve 30 on the upper surface 16 of the body portion 12. The sleeve 30 connects the handle 14 to the body portion 12 and may also help reinforce the connection between the handle and the body portion. The gripping portion 22 is connected to a second end 26 of the shaft 20, opposite the first end 24, and extends perpendicular to the shaft.

In the embodiment illustrated in FIGS. 1-4, the gripping portion 22 and the shaft 20 each have a generally cylindrical configuration. Those skilled in the art, however, will recognize that the handle 14 may have an alternative configuration. For example, the gripping portion 22 and/or the shaft 20 may have a contoured configuration selected to provide an aesthetic appearance and/or an ergonomic feel. Also, the body portion 12 and the handle 14 may be separate pieces assembled to form the spanner wrench 10, or they may be molded or otherwise formed as a single piece of homogeneous material.

The spanner wrench 10 also includes a fixed drive pin 40 and a movable drive pin 42. The fixed drive pin 40 and the movable drive pin 42 each have a generally cylindrical shape and extend in a perpendicular direction from a lower surface 44 of the body portion 12, opposite the upper surface 16. Those skilled in the art, however, will recognize that the drive pins 40 and 42 may have alternative shapes, such as pins having a hexagonal or square cross-section.

As illustrated in FIG. 2, the fixed drive pin 40 and the movable drive pin 42 are seated in a channel 50 in the body portion 12. The channel 50 has a rectangular configuration and extends along a substantial portion of the length of the body portion 12. The fixed drive pin 40 and the movable drive pin 42 each have a rectangular base portion 52 that is received in the channel 50. The dimensions of the channel 50 and the base portions 52 may be selected so as to provide a clearance fit between the channel and the drive pins 40 and 42, which would allow the drive pins to pivot or rotate slightly with respect to the body portion 12. A spring 54 is disposed in the channel 50 between the fixed drive pin 40 and the movable drive pin 42. The spring 54 has a first end 56 that engages the base portion 52 of the fixed drive pin 40, and an opposite second end 58 that engages the base portion of the movable drive pin 42.

The body portion 12 of the spanner wrench 10 also includes a retainer plate 60 for retaining the fixed drive pin 40, the movable drive pin 42, and the spring 54 in the channel 50. The retainer plate 60 is connected to the body portion 12 by suitable fastening means 62, such as screws, and thus helps form the lower surface 44 of the body portion 12. The retainer plate 60 includes a cylindrical opening 64 and an elongated slot 66, each of which extend through the retainer plate. The slot 66 has a first end 70 positioned adjacent the opening 64 and an opposite second end 72.

When the spanner wrench 10 is in the assembled condition of FIG. 1, the opening 64 and the slot 66 overlie the channel 50. The fixed drive pin 40 extends through the opening 64 and the movable drive pin 42 extends through the slot 66. The diameter of the opening 64 is larger, preferably only slightly larger, than the diameter of the fixed drive pin 40. The width of the slot 66 is larger, preferably only slightly larger, than the diameter of the movable drive pin 42.

The fixed drive pin 42 has a fixed position relative to the body portion 12. The opening 64 in the retainer plate 60 retains the fixed drive pin 40 in a fixed position relative to the body portion 12. The movable drive pin 42 is movable relative to the body portion 12. The slot 66 in the retainer plate 60 permits the movable drive pin to slide in the channel 50 and along the length of the slot.

The movable drive pin 42 is movable in a first linear direction, away from the fixed drive pin 40, and in an opposite second linear direction towards the fixed drive pin. The first linear direction is indicated generally by the arrow labeled 80 in FIG. 1, and the second linear direction is indicated generally by the arrow labeled 82 in FIG. 1.

The spring 54 biases the movable drive pin 42 in the first linear direction away from the fixed drive pin 40. Thus, in a normal condition as illustrated in FIG. 1, the movable drive pin 42 is positioned at the second end 72 of the slot 66. The movable drive pin 42 is slidable in the second linear direction against the bias of the spring 54.

FIG. 3 illustrates a typical removable cover 100 that is located in a housing 102 recessed from a surface 104. The cover 100 includes spaced sockets 110 which may be accessed to impart rotational movement to the cover in order to remove or connect the cover. The housing 102 has a generally rectangular configuration and has dimensions that create a confined space adjacent the cover 100.

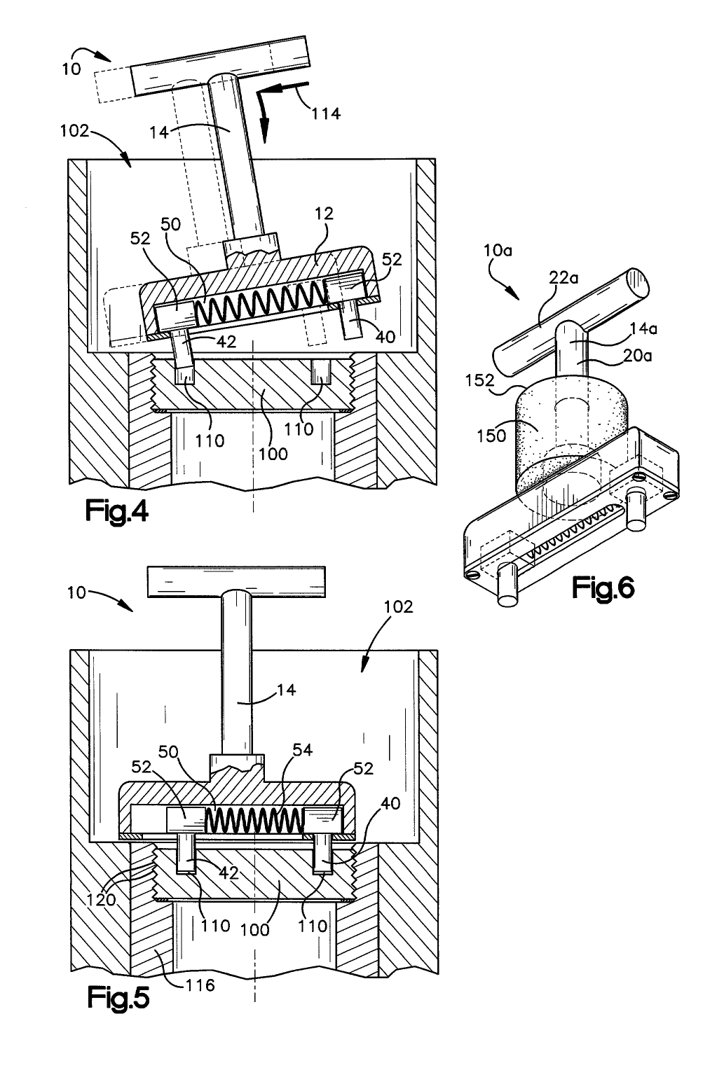

Referring now to FIGS. 4 and 5, the manner in which the spanner wrench 10 adjusts to fit the sockets 110 in the cover 100 to remove the cover is illustrated. As shown in FIG. 4, the handle 14 is used to maneuver the spanner wrench 10 in the housing 102. The movable drive pin 42 is guided to be inserted into one of the sockets 110. The slight clearance fit between the channel 50 and the base portion 52 of the movable drive pin 42, if present, may help to allow the movable drive pin to be maneuvered into the socket 110 by allowing the drive pin to rotate or pivot slightly with respect to the body portion 12.

Once the movable drive pin is inserted into one of the sockets 110, the fixed drive pin 40 is maneuvered into the other of the sockets 110. The spanner wrench 10 is moved, via the handle 14, in the direction indicated generally by the arrow labeled 114 in FIG. 7. Because the movable drive pin 42 is inserted in the socket 110, the channel 50 slides on the base portion 52 of the movable drive pin 42 and the body portion 12 of the spanner wrench 10 moves relative to the movable drive pin against the bias of the spring 54 to the position indicated generally by the dashed lines in FIG. 4.

The fixed drive pin 40 moves along with the body portion 12 in the direction indicated by the arrow labeled 114. As the fixed drive pin 40 moves in the direction indicated by the arrow labeled 114, the fixed drive pin becomes aligned with the socket 110 opposite the socket containing the movable drive pin 42. When the fixed drive pin 40 is aligned with the socket 110, the spanner wrench 10 can be pivoted in the direction indicated generally by the curved arrow labeled 116 in FIG. 4. As the spanner wrench 10 is pivoted, the fixed drive pin is moved into the socket as illustrated in FIG. 5.

When the spanner wrench 10 is in the position illustrated in FIG. 5, a rotational force may be imparted to the cover 100 by applying a rotational force to the handle 14. This causes the cover 100 to rotate with the spanner wrench 10 in the direction of the rotational force. The spanner wrench 10 thus can be used to attach or remove the cover 100 from the container 116 via screw threads 120 which connect the cover to the container.

Preferably, the spanner wrench 10 is constructed of a plastic material. It may be desireable to construct certain components of the spanner wrench 10 from a material other than plastic. For example, the fastening means 62 and the spring 54 would likely be constructed of a metal material. The drive pins 40 and 42 may also be constructed of a metal material to provide increased strength and durability. In fact, it may even be desirable to construct the spanner wrench 10 entirely of a metal, such as aluminum, in order to provide strength and durability.

One particular scenario in which the spanner wrench 10 may be utilized in a marine setting, particularly on boats, yachts, or other watercraft wherein fuel, water, and other storage tanks may require the use of a spanner wrench to connect or remove the lids thereof. Advantageously, the spanner wrench 10 is preferably constructed in a manner such that the spanner wrench floats in water. Such construction helps to facilitate easy retrieval should the spanner wrench 10 be accidentally dropped in water.

In order to provide the spanner wrench 10 with the ability to float in water, components of the spanner wrench may be constructed of a material having buoyant characteristics. For example, the body portion 12, handle 14, drive pins 40 and 42, and the retainer plate 60 may be constructed of a buoyant plastic, such as polyethylene. Also, the body portion 12 and the handle 14 may have hollowed portions (not shown) in order to reduce the weight of the spanner wrench 10.

Those skilled in the art will recognize that polyethylene, having a density of about 0.94 grams per cubic centimeter, may display a degree of buoyancy just sufficient to cause the spanner wrench 10 to float in water. Also, as described above, components of the spanner wrench 10 may not be constructed of plastic, which would help to decrease the overall buoyancy of the spanner wrench. Therefore, the spanner wrench 10 may include means by which to increase the overall buoyancy of the wrench.

A second embodiment of the present invention is illustrated in FIG. 6. The second embodiment of the invention is similar to the first embodiment of the invention illustrated in FIGS. 1-5. Accordingly, numerals similar to those of FIGS. 1-5 will be utilized in FIG. 6 to identify similar components, the suffix letter “a” being associated with the numerals of FIG. 6 to avoid confusion. The second embodiment of the present invention is identical to the first embodiment (FIGS. 1-5), except that the spanner wrench 10a of the second embodiment (FIG. 6) includes a flotation device 150 for enhancing the buoyancy of the spanner wrench.

As illustrated in FIG. 6, the flotation device 150 has a generally ring-shaped configuration and is fitted over the shaft 20a of the handle 14a. This configuration is illustrative of one particular configuration for connecting a flotation device to the spanner wrench 10a. Those skilled in the art will recognize that there are many alternative methods by which to attach a flotation device to the spanner wrench 10a. For example, a flotation device may be connected to the spanner wrench 10a by a flexible elongated member, such as a strap or a rope.

The dimensions of the flotation device 150 are such that a clearance is established between an upper surface 152 of the flotation device and the gripping portion 22a of the handle 14a. This allows the gripping portion 22a to be grasped in order to use the spanner wrench 10a while the flotation device 150 remains attached to the spanner wrench. The flotation device 150 helps to facilitate easy retrieval should the spanner wrench 10a be accidentally dropped in water.

From the above description of the invention, those skilled in the art will perceive improvements, changes and modifications. Such improvements, changes and modifications within the skill of the art are intended to be covered by the appended claims.

Having described the invention, the following is claimed:

1. An adjustable spanner wrench comprising:
a body portion;
a handle connected to said body portion;
a fixed drive pin fixedly connected to said body portion;
a movable drive pin connected to said body portion, said movable drive pin being slidable relative to said body portion in a first linear direction away from said fixed drive pin and in an opposite second linear direction towards said fixed drive pin; and
a biasing member that biases said movable drive pin in said first linear direction away from said fixed drive pin.

2. The adjustable spanner wrench of claim 1, wherein said fixed drive pin and said movable drive pin extend from a lower surface of said body portion, said handle extending from an opposite upper surface of said body portion.

3. The adjustable spanner wrench of claim 2, wherein said handle extends generally perpendicularly from said upper surface of said body portion.

4. The adjustable spanner wrench of claim 3, wherein said handle has a generally T-shaped configuration, said handle comprising a vertical member and a cross-member, said vertical member having a first end connected to said upper surface of said base portion and an opposite second end, said cross-member being connected to said second end of said vertical member and extending generally perpendicular to said vertical member.

5. The adjustable spanner wrench of claim 1, wherein said body portion includes a channel that extends at least partially through said base portion, said channel forming a slot extending along said lower surface of said base portion, said movable drive pin having a first portion positioned in said channel and a second portion extending through said slot, said first portion being slidable along said channel in said first direction, said second portion being slidable with said first portion in said slot.

6. The adjustable spanner wrench of claim 5, wherein said biasing member is positioned in said channel between said fixed drive pin and said movable drive pin, said biasing member having a first end that engages said fixed drive pin and an opposite second end that engages said movable drive pin, said biasing member biasing said movable drive pin towards said second end wall of said channel.

7. The adjustable spanner wrench of claim 1, wherein said biasing member comprises a spring.

8. The adjustable spanner wrench of claim 1, wherein said spanner wrench floats in water.

9. The adjustable spanner wrench of claim 8, wherein said handle is constructed of a material that floats in water, said handle having a buoyancy sufficient to cause said adjustable spanner wrench to float in water.

10. The adjustable spanner wrench of claim 8, wherein said base portion is constructed of a material that floats in water, said base portion having a buoyancy sufficient to cause said adjustable spanner wrench to float in water.

11. The adjustable spanner wrench of claim 1, wherein said handle and said base portion are constructed of a single piece of homogeneous material.

12. The adjustable spanner wrench of claim 11, wherein said material floats in water, said material having a buoyancy sufficient to cause the adjustable spanner wrench to float in water.

13. The adjustable spanner wrench of claim 1, further comprising a flotation device connected to said adjustable spanner wrench, said flotation device having a buoyancy sufficient to cause the adjustable spanner wrench to float in water.

14. The adjustable spanner wrench of claim 13, wherein said flotation device is connected to said handle.
